(19) United States
(12) Patent Application Publication
(10) Pub. No.: US 2012/0055413 A1
(43) Pub. Date: Mar. 8, 2012

(54) ACCLIMATIZATION AND ISOLATION DEVICE FOR AQUATIC ANIMALS

(76) Inventor: Suk Choo KIM, Bayside, CA (US)

(21) Appl. No.: 12/957,775

(22) Filed: Dec. 1, 2010

(30) Foreign Application Priority Data
Sep. 2, 2010 (CN) 201010281350.1
Sep. 2, 2010 (CN) 201020523744.9

(51) Int. Cl. A01K 63/00

(52) U.S. Cl. 119/251

(57) ABSTRACT

Disclosed herein is an acclimation and isolation device for aquatic animals that includes a case with a fastener on a lateral face thereof to coordinate with said case in an aquarium and a water entry apparatus to conduct the aquarium water into said case. The water entry apparatus includes a water inlet on a bottom of said case and a valve attached to said inlet.

### PRIORITY

This application claims priority under 35 U.S.C. §119(a) to Chinese Patent Applications filed in the Chinese Industrial Property Office on Sep. 2, 2010 and assigned Serial Nos. 201020523744.9 and 201010281350.1, the contents of which are incorporated herein by reference.

### BACKGROUND

This invention relates generally to aquarium construction and, in particular, devices to acclimatize an aquarium feeding device.

### FIELD OF THE INVENTION

Aquatic animals such as fish, coral or invertebrates are extremely sensitive to changes in their environment. Significant changes to water parameters can have a dramatic effect on the health of the aquatic inhabitants. Important water parameters such as temperature, pH, salinity, and mineral and trace element composition should not fluctuate or change much over time. A sudden change in any of these conditions can result in shock, which can cause disease or death. To successfully introduce new aquatic life into an aquarium, it is necessary for the animals to become acclimated to the new environment with as little trauma or stress as possible.

It is well know that acclimating aquatic animals to their new environment is an important step to decreasing their morality rate upon introduction.

The most common method to acclimate aquatic animals is to float the transporting container, usually a clean plastic bag, in the aquarium for a period of time, normally thirty minutes to an hour. The heat transferring between the aquarium and the transport container will allow the temperature inside of the container to equal the temperature of the aquarium water. Once this is complete, the new inhabitant can be released into the new aquarium. While this method will acclimate the new animal to the aquarium water temperature, it will not acclimate them to the pH, salinity and chemical composition of the new environment. Additionally, the bright and unimpeded aquarium light can cause stress for the new animal unless it is turned off before floating the transport container and using this method. This method also does not allow the user to minimize the addition of transportation water into the aquarium, which can contribute to spreading disease and pollutants in the aquarium.

Alternatively, to enable better acclimation to water composition, users would augment this previous method by periodically adding small amounts of water to the transport container every few minutes for 30 minutes or longer. This method requires the user to open and close the plastic bag many times through the procedure, or it requires the use of a rigid container that can be attached to the tank and left open without tipping over. This method can produce reasonable results, but is labor and time intensive, and requires regular attention throughout the process.

Many articles in aquatic hobby periodicals and websites suggest using a drip method to introduce aquatic life into new marine environments. This method is similar to the method of manually adding aquarium water to the transport container, but instead uses a valve to add a small amount of the new aquarium water at a regulated rate. While this method is an improvement to the bag-floating method and the method including manually adding water to the transport container, it also is time consuming and requires the user to pay close attention to avoid flooding the new container. If left unattended, the drip system could overflow the transport container, resulting in large amounts of spilled aquarium water, and a reduced water level in the aquarium. The user must also replenish the new aquarium, so the water level does not decrease to the point where equipment, e.g. pumps in the aquarium system could be damaged during the drip process.

A device designed to acclimate aquatic animals more effectively than these previously discussed methods is described by U.S. Pat. No. 3,491,772 to Levitov et al., the contents of which is incorporated herein by reference. The device described by Levitov uses hydrostatic pressure in conjunction with a collar device, a locking mechanism and an acclimating case. Though acclimation is achieved more effectively than in previously discussed methods, the complicated and difficult task of operating this device underscores its shortcomings. For example, the user must overcome the buoyancy of a mostly empty acclimation case, simultaneously push the case into the aquarium while coordinating its placement within the collar, and then lock the unit in place. Furthermore, the placement of the valve inlet does not allow the user to easily verify the amount of water entering the acclimating case. Another consideration is that recently transported fish often exhibit skittish behavior due to the trauma associated with the change. Without a lid, this device is susceptible to allowing fish to jump out of the case, possibly causing more harm and death to the fish.

A similar device as the one described by Levitov has the water inlet at the bottom of the acclimating case. Instead of locking the unit into a collar, this unit is floated in the aquarium and water enters the case from the bottom of the unit. Once the case is full, it sinks to the bottom of the aquarium and releases the fish. Though more simple than the Levitov device, this method causes the user to have to retrieve the case from the bottom of the aquarium, which can be inconvenient, particularly in deeper aquariums. This method can also result in damage or injury to sessile inhabitants in the aquarium when the case sinks, since the placement and timing of the device cannot be set or stopped without constant attention. Additionally, using this method does not allow the user to prevent the incorporation of transportation water to the aquarium, nor does it allow the user to test and compare the water samples before releasing the new animal into the aquarium.

Another device to address aquatic acclimation is described by U.S. Pat. No. 4,188,909 to Spivak et al., the contents of which are incorporated herein by reference. The method described by Spivak utilizes two containers, one on top of another, connected via a valve where aquarium water is added to the upper container and the lower container contains the aquatic animals and transport water. The device is submerged into the aquarium, allowing the top container to remain above the aquarium water level. Acclimation is achieved by adding aquarium water to the top container, then adjusting the valve to incorporate the water at a specified rate. Though this method achieves acclimation through a regulated drip valve, the device suffers from similar challenges faced when using the Levitov device. This design requires the user to submerge an almost empty container into the aquarium, which can be very difficult to balance and keep submerged without the aid of a locking mechanism to overcome the buoyancy of the container. Also, by submerging a relatively large empty container, the volume of water being displaced needs to be accounted for either by having extra room in the aquarium or by initially manually removing the volume of water. This design, while reasonably effective, is overly difficult to use, requiring the user to set up a relatively large system and fill the first container as needed. This device is also more costly to produce than what is needed to achieve better acclimation results.

Accordingly, the present invention provides a simple and effective device for automatic aquatic acclimation in order to minimize the amount of shock and trauma experienced by the animal before being added to a new environment, while providing a simple means to accomplish water chemistry and social acclimation as well.

### SUMMARY OF THE INVENTION

To overcome the deficiencies of conventional systems, the present invention accomplishes acclimation without requiring users to constantly or intermittently monitor the device, thereby reducing the labor and time intensive nature of existing options.

Additionally, other objects of the device include providing a means for extended social acclimation, while simplifying the manner of release of a new animal in the aquarium, while controlling the amount of transport water that is incorporated.

The previously discussed objects among others will be achieved with the present device for automatic aquatic acclimation wherein said acclimation and isolation device includes a case equipped with a fastener on its lateral face to fix the case into an aquarium, and a water entry apparatus used to conduct the water of the aquarium into the case; additionally, a cover on top of the case to prevent recently transported fish from escaping, made of colored transparent material to prevent strong light affecting the acclimation of the new aquatic life.

Further, the water entry apparatus preferably includes a water inlet on the bottom of the case and a water valve to control the rate of water flow

Overflow holes in the upper section of the lateral face of the case provides an emergency overflow outlet as well as a circulation outlet when used as an isolation case.

The fastener includes a slider block fixed on the lateral face of said case, and an installation base including a slider slot to coordinate with said slider block. The installation base includes a horizontal installing slot and a vertical installing slot with a screw locking mechanism and an adjustable height stop mechanism, with stop holes on both sides of said sliding slot and arresting pins installed in said stop holes. Further, the case includes racks to support coral or coral plugs, and protruding ribs to support said racks.

Said case could be a cuboid case having a flat bottom, a semi-cylindrical case having a flat bottom, a tri-prism case having a flat bottom, a cuboid case having a cone-shaped bottom, or a cuboid case having an arch-shaped bottom.

The device provides a method for the aquarium water to be gradually transferred from the aquarium into the case due to gravity, whereby the aquatic animal is easily and automatically acclimated to the new environment without any additional monitoring.

The present device further improves safe acclimation of aquatic animals by acting as an isolation tank for recent additions to a system that may have special behavioral needs. For use as an isolation device, a water pump is connected to the water valve whereby aquarium water is actively circulated into the isolation tank allowing proper, longer term, social acclimation to be achieved.

### BRIEF DESCRIPTION OF THE DRAWINGS

For a better understanding of the invention as well as other objects and further features thereof, reference is made to the following detailed description to be read in conjunction with the accompanying drawings, wherein:

FIG. 1 is a schematic view of a first embodiment of the present invention;

FIG. 2 is a schematic view of the first embodiment shown acclimating a fish in the case of the present invention;

FIG. 3 is a schematic view about the device of the first embodiment installed on an aquarium;

FIG. 4 is an exploded view of the first embodiment of the present invention;

FIG. 5 is a front perspective view of the case of the first embodiment of the present invention;

FIG. 6 is a rear perspective view of the case in the first embodiment of the present invention;

FIG. 7 is a rear perspective view of the installation base in the first embodiment of the present invention;

FIG. 8 is a front perspective view of the installation base in the first embodiment of the present invention;

FIG. 9 is a rear perspective view about the installation base equipped with arresting pins in the first embodiment of the present invention;

FIG. 10 is a schematic view about the installation base equipped with a horizontal installing sliding slot in the first embodiment of the present invention;

FIG. 11 is a schematic view about the installation base equipped with a vertical installing slot in the first embodiment of the present invention;

FIG. 12 is a front view of the cover of the case in the first embodiment of the present invention;

FIG. 13 is a rear view of the cover of the case in the first embodiment of the present invention;

FIG. 14 is a three-dimensional sectional view of the case in a second embodiment of the present invention;

FIG. 15 is a three-dimensional sectional view of the case provided with racks in the second embodiment of the present invention;

FIG. 16 is a sectional view of the case in the second embodiment of the present invention;

FIG. 17 is a sectional view of the case equipped with racks in the second embodiment of the present invention;

FIG. 18 is a three-dimensional view of the racks in the second embodiment of the present invention;

FIG. 19 is a three-dimensional view of the case in a third embodiment of the present invention;

FIG. 20 is a three-dimensional view of the case in a fourth embodiment of the present invention;

FIG. 21 is a three-dimensional view of the case in a fifth embodiment of the present invention; and

FIG. 22 is a three-dimensional view of the case in a sixth embodiment of the present invention.

### DESCRIPTION OF THE PREFERRED EMBODIMENTS

The following detailed description of preferred embodiments of the invention is made with reference to the accompanying drawings. In describing the invention, explanation of related functions or constructions known in the art is omitted for the sake of clearness in understanding the concept of the invention, to avoid obscuring the description of the invention with unnecessary detail.

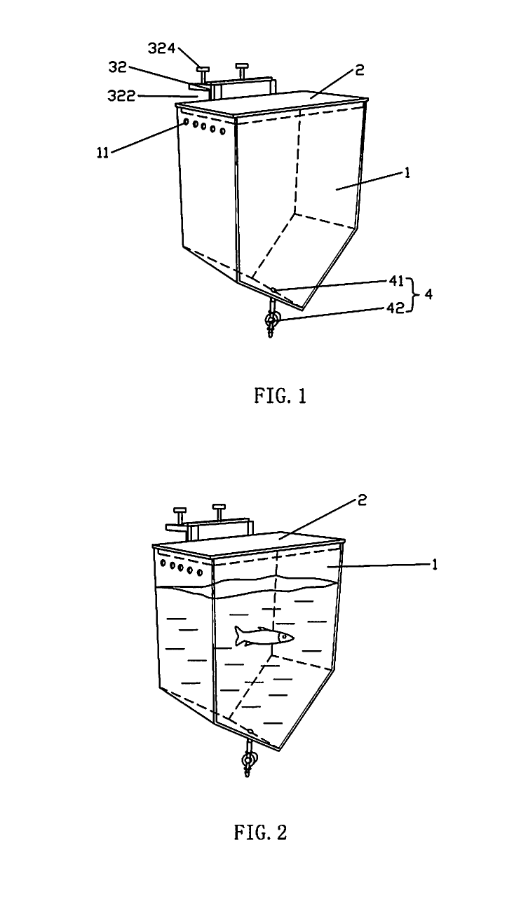

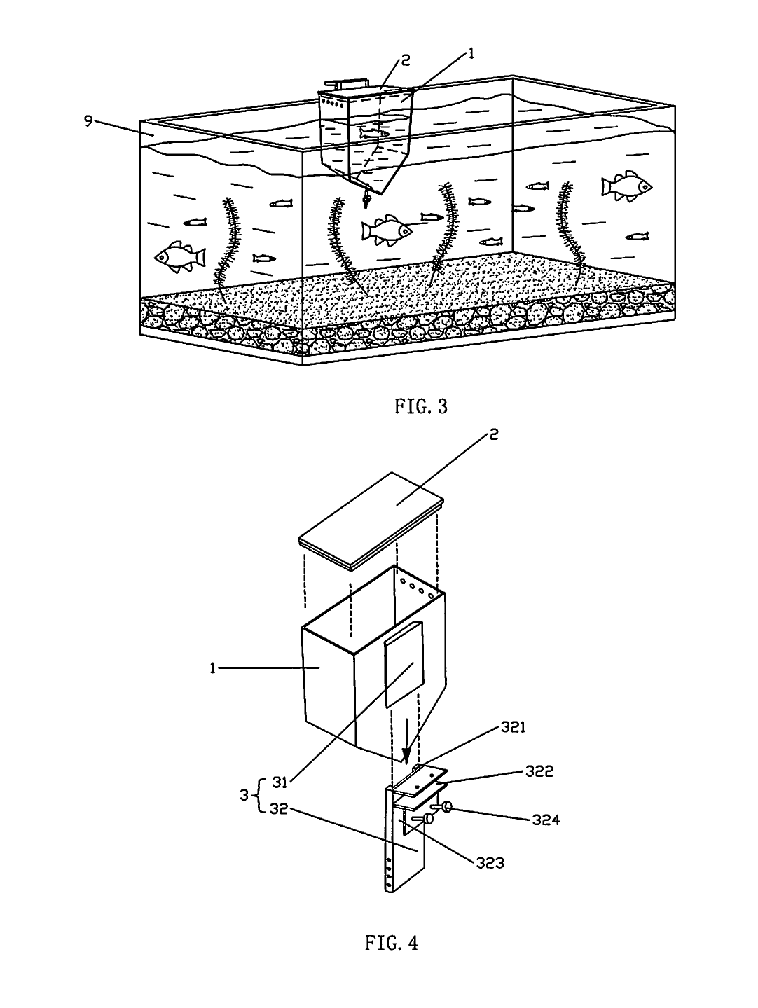

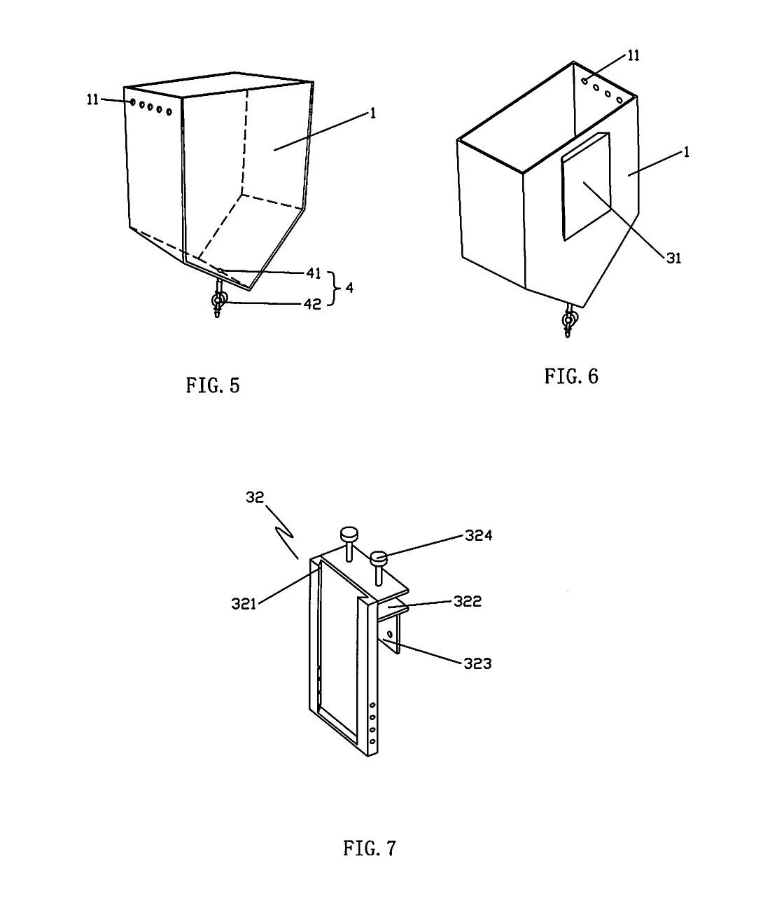

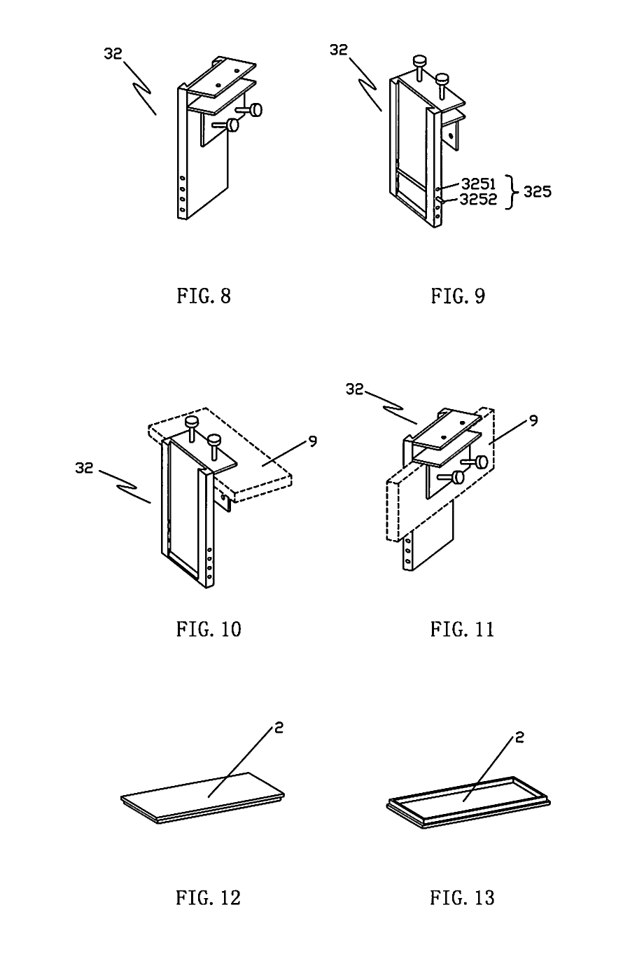

In a first preferred embodiment, reference is made to FIGS. 1-13 showing an acclimation device for aquatic animals that includes a case 1 and a cover 2. Case 1 has a fastener 3 (FIG. 4) on its lateral face that is used to fix said case 1 into an aquarium 9, and a water entry apparatus 4 used to conduct the water of aquarium into the case 1.

Further, said water entry apparatus 4 includes a water inlet 41 on a bottom of the case 1 and a water valve 42 arranged in the water inlet 41; and the water valve is provided with a knob to control the water flow rate.

To be more specific, the case 1 is cuboid shaped with a cone-shaped bottom, and both of said case 1 and its cover 2 are made of colored transparent material to prevent the intense aquarium light from causing trauma and stress to the new fish.

Overflow holes 11 are provided on the upper section of the lateral face of the case 1 to limit the water held in the case 1. If the water in said case 1 needs to be drained with fish inside, the user can hold said cover 2 on top of the case 1 while inclining the case 1 towards the over flow holes 11. This will allow the water to flow out while preventing the fish from jumping out of said case 1.

Referring to FIGS. 7 to 11, a fastener 3 is provided that is easy to install and uninstall, with the fastener including a slider block 31 fixed on one side of the case 1, and an installation base 32 having a sliding slot 321 to coordinate with said slider block 31. The installation base 32 consists of a horizontal installing slot 322 or/and a vertical installing slot 323. As a preferred embodiment, said installation base 32 includes both a horizontal installing slot 322 and a vertical installing slot 323. Said horizontal installing slot 322 and said vertical installing slot 323 are provided with a screw locking mechanism 324, allowing the user to choose said horizontal installing slot 322 or said vertical installing slot 323 to fix the installation base 32 on the aquarium. A height adjusting mechanism 325 is provided on the sliding slot 321, including stop holes 3251 running parallel on both sides of said sliding slot 321 and arresting pins 3252 installed between said stop holes 3251. Depending on said arresting pins 3252 being installed on stop holes 3251 at different levels, said case 1 can be fixed at different heights.

The device of the present invention is preferably used with the installation base 32 is first installed. According to the actual structure of the aquarium, the installation can be done by choosing the horizontal installing slot 322 or vertical installing slot 323 to hang the case 1 onto the aquarium 9. Next, the screw locking mechanism 324 is locked, the water with fish is then poured into said case 1, said cover 2 is then be closed, and said slider block 31 would then be set into said sliding slot 321. Next, the user adjusts the height of said case 1 and ensures the bottom of said case 1 is lower than the level of the water in the aquarium 9. The user can install arresting pins 3252 in preferred stop holes 3251 to limit where the case 1 will stop. When the water vent valve 42 is opened, the water in aquarium 9 slowly passes into said case 1 via gravity or pressure difference between said case 1 and said aquarium 9, and the water of said case 1 mixes with the new aquarium 9 water.

In summary, the user hangs the case of the present device on the aquarium independently, and transfers the water of aquarium into said case slowly through the water vent valve. This procedure successfully acclimates the new aquatic animal to the temperature and composition of water in the aquarium while protecting the new arrivals from being attacked by the existing inhabitants of the aquarium.

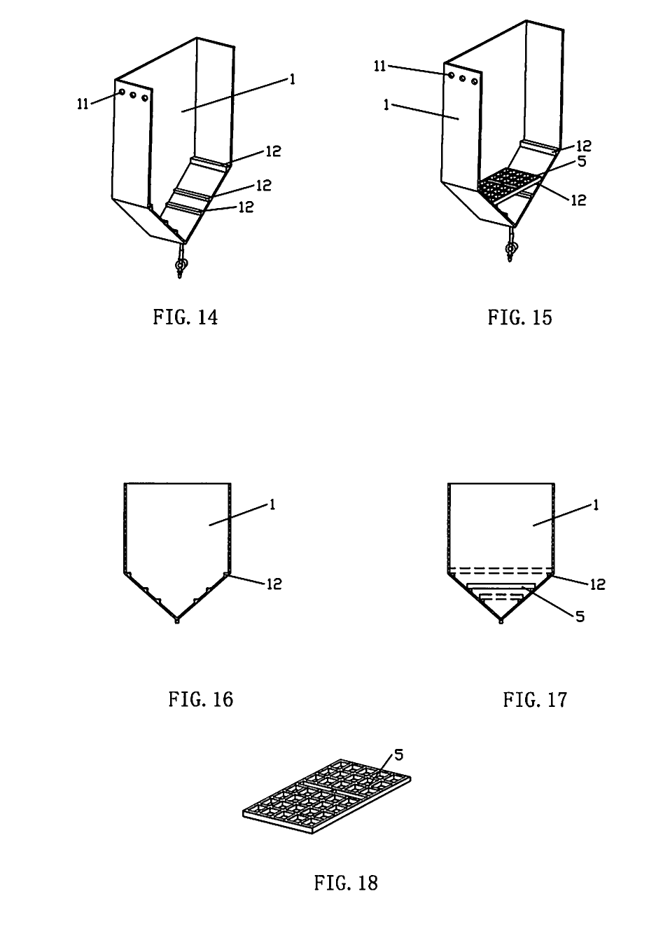

In a second preferred embodiment, reference is made to FIGS. 14 to 18, which illustrates an acclimation and isolation device for aquariums and aquatic animals including a case 1 and a cover 2. The case 1 has a fastener 3 on its lateral face that is used to fix the case 1 on an aquarium 9, and a water entry apparatus 4 used to conduct the water of aquarium into the case. The case 1 is cuboid shaped with a cone-shaped bottom, preferably, the preferred embodiment including racks 5 to support other animals such as coral, and protruding ribs 12 to support on or more of said racks 5. Other configuration about the device of this embodiment are similar to the description provided for embodiment 1.

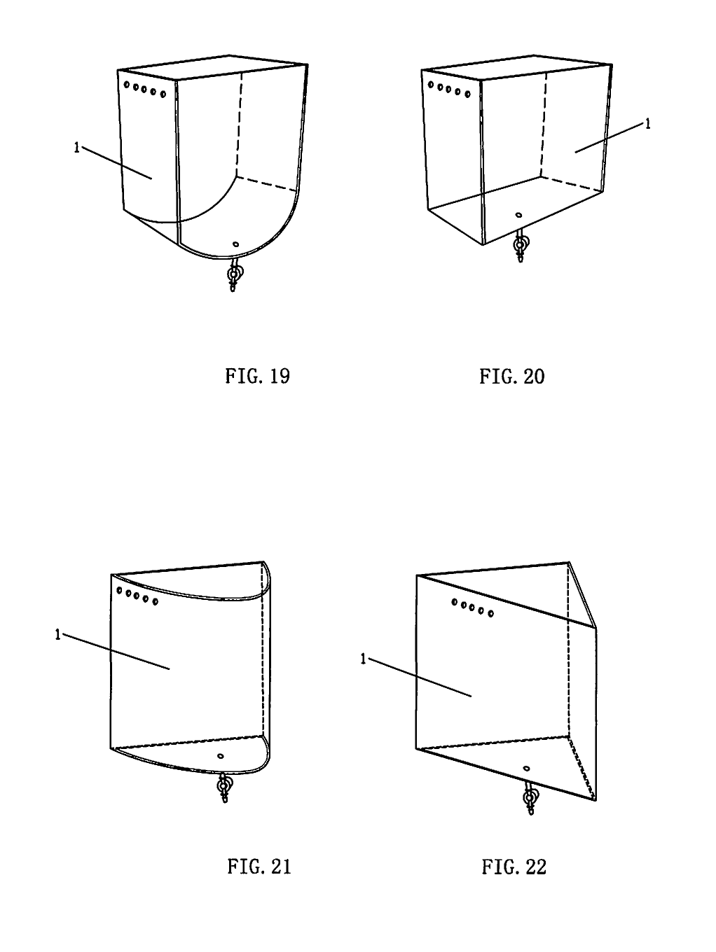

Referring to FIG. 19, a third embodiment is shown of the acclimation and isolation device for aquariums and aquatic animals, similarly including a case 1 and a cover 2. The case 1 has a fastener 3 on its lateral face used to fix the case 1 on an aquarium 9, and a water entry apparatus 4 used to conduct the water of aquarium into the case 1. The case 1 is cuboid shaped with arch-shaped bottom in this embodiment. Referring to FIG. 20, a fourth embodiment is shown of the acclimation and isolation device for aquariums and aquatic animals, similarly including a case 1 and a cover 2. The case 1 has a fastener 3 on its lateral face used to fix the case 1 on an aquarium 9, and a water entry apparatus 4 used to conduct the water of aquarium into the case 1. The case 1 is cuboid shaped with flat bottom in this embodiment.

Referring to FIG. 21, a fifth embodiment is shown of the acclimation and isolation device for aquariums and aquatic animals, similarly including a case 1 and a cover 2. The case 1 has a fastener 3 on its lateral face used to fix the case 1 on an aquarium 9, and a water entry apparatus 4 used to conduct the water of aquarium into the case 1. The case is a semi-cylindrical shaped with a flat bottom, in this embodiment.

Referring to FIG. 22, a sixth embodiment is shown of the acclimation and isolation device for aquariums and aquatic animals, similarly including a case 1 and a cover 2. The case 1 has a fastener 3 on its lateral face used to fix the case 1 on an aquarium 9, and a water entry apparatus 4 used to conduct the water of aquarium into the case 1. Said case is a tri-prism shaped having a flat bottom, in

A seventh embodiment of the acclimation and isolation device for aquariums and aquatic animals similarly includes a case 1 and a cover 2, with a fastener on a lateral face to fix the case into an aquarium, and a water entry apparatus to conduct the water of aquarium into the case. The water entry apparatus of the seventh embodiment includes an optional pump to pump the water from the aquarium into the case via the water entry apparatus between the case and the aquarium.

The foregoing disclosure is preferable, and should not be taken to limit of the scope of the present device, wherein said case could be including but not limited to a cuboid case having a flat bottom, a semi-cylindrical case having a flat bottom, a tri-prism case having a flat bottom, a cuboid case having a cone-shaped bottom, or a cuboid case having an arch-shaped. The fastener should not be limited in above description; and can also utilize suction cups, pothooks and other structures.

The invention is not limited to the disclosed preferred embodiment, and should be construed to cover all such alternatives, modifications and equivalents as defined in the appended claims.

What is claimed is:

1. An acclimation and isolation device for aquatic animals comprising:
a case having a fastener on a lateral face thereof to coordinate with said case in an aquarium; and
a water entry apparatus to conduct the aquarium water into said case.

2. The device of claim 1, wherein said water entry apparatus comprises a water inlet on a bottom of said case and a valve attached to said inlet.

3. The device of claim 2, wherein said valve controls water flow rate.

4. The device of claim 1, wherein said water entry apparatus includes a tube and a pump between said case and said aquarium.

5. The device of claim 1, wherein said case has a cover on a top thereof.

6. The device of claim 5, wherein said case and said cover are made of colored transparent material.

7. The device of claim 1, wherein the lateral face of said case has over flow holes at an upper section thereof.

8. The device of claim 1, wherein said fastener comprises a slider block fixed on the lateral face of said case, and an installation base having a sliding slot coordinated with said slider block.

9. The device of claim 8, wherein said installation base comprises a horizontal installing slot and a vertical installing slot.

10. The device of claim 9, wherein said horizontal vertical installing slot and vertical installing slot are provided with a screw locking mechanism.

11. The device of claim 8, wherein said sliding slot has an adjustable height stop mechanism.

12. The device of claim 11, wherein said adjustable height stop mechanism comprises installing holes on both sides of said sliding slot and arresting pins between said installing holes.

13. The device of claim 1, further comprising racks and protruding ribs to support said racks.

14. The device of claim 1, wherein said case is a cuboid shaped with a flat bottom.

15. The device of claim 1, wherein said case is a semi-cylindrical case having a flat bottom.

16. The device of claim 1, wherein said case is a tri-prism case having a flat bottom.

17. The device of claim 1, wherein said case is a cuboid case having a cone-shaped bottom.

18. The device of claim 1, wherein said case is a cuboid case having an arch-shaped.
